(19) United States
(12) Patent Application Publication
(10) Pub. No.: US 2026/0145020 A1
(43) Pub. Date: May 28, 2026

(54) TORQUE SENSOR FOR RESISTANCE SYSTEM

(71) Applicant: Lily Lin, Yuanshan Township (TW)

(72) Inventor: Lily Lin, Yuanshan Township (TW)

(21) Appl. No.: 18/956,517

(22) Filed: Nov. 22, 2024

(51) Int. Cl. A63B 21/22; A63B 22/06

(52) U.S. Cl. CPC A63B 21/225; A63B 22/0605; A63B 2220/54; A63B 2220/833; A63B 2225/682

(57) ABSTRACT

A torque sensor for resistance system, comprising: a bracket, a torque sensor, including a strain block, arranged arranged on the same straight line as the axis center of the flywheel and the center of the coil reluctance mechanism, the strain gauge will produce different resistance value changes according to the deformation amount of the strain block; and a control circuit received the change in the resistance value of the torque sensor, then calculates the change in resistance, and compares the difference between the required resistance and the actual resistance to adjust the amount of force to make the required resistance consistent with the actual resistance.

### BACKGROUND OF THE INVENTION

### 1. Field of the Invention

The invention relates to a torque system for resistance system, especially to one that uses the change in its resistance value as a magnetic detection device, and uses the obtained magnetic data for correcting the output current for the torque sensor device.

### 2. Description of the Related Art

Resistance (tension) control is used in many applications, such as resistance systems in fitness equipment, resistance control in medical rehabilitation equipment, or even tension control in commercial or industrial equipment. It has a wide range of applications.

Referring to FIG. 1A, discloses an electromagnetic resistance system 10A of prior art, it includes a flywheel 11 with its axis 12 mounted on a bracket 13, and one or more coils 14 are provided on the side of the flywheel 11. When the coils 14 are energized, a magnetic field is generated, then uses the magnetic permeability properties of the surface material of the flywheel 11 to cause a magnetic circuit to be formed between the coil core and the flywheel, and when the flywheel 11 rotates, according to Lenz's law, the flywheel 11 generate a same amount rotational resistance with the opposite direction of rotation.

Referring to FIG. 1B, discloses a self energy generating resistance system 10B of prior art, which has roughly the same structure as the above-mentioned electromagnetic resistance system 10A. The difference is that the coil 14 of the electromagnetic resistance system 10A requires an external power supply. As for the self energy generating resistance system 10B, the flywheel 11 is equipped with a power generation device 15, which can generate electricity through the rotation of the flywheel 11, thereby providing the power required by the coil 14 to generate a self energy generating resistance system.

These two resistance systems 10A and 10B is mature product, so the technique and the feature will not be mentioned in this description, said system can be found in the prior art, China patent No. CN201204540, Taiwan patent No. M420342, U.S. Pat. No. 6,084,325.

The above-mentioned resistance (tension) system relies on controlling the magnitude of the current input to the coil 14 to control the magnitude of the magnetic force generated(Current x Number of coil windings =magnetic force), that is, the magnitude of the resistance or tension.

Referring to FIG. 1C, under the status without measurement sensors as feedback, the control of magnetic force (i.e. resistance or tension) is difficult to achieve precise control requirements. The general control method is to measure the resistance curve of the device in advance when the resistance system is completed, which includes parameters such as current, speed and power and forms a power table, and when we need to control its resistance, we can first detect the current speed of the equipment, check the current required for the required resistance (tension) corresponding to the speed, and then control the resistance (tension) of the electromagnetic resistance system 10A, 10B by controlling the current, so as to generate corresponding resistance (tension).

Therefore, we can see that this is an “open loop system”, there is no feedback and compensation to correct the results, and the electromagnetic resistance system 10A or 10B will encounter many factors that will affect the magnitude of the magnet force during the resistance generation process. For example, the operation time, the temperature of the flywheel, the temperature of the coil, the size of the gap between the flywheel and the iron core, etc. Because these factors will affect the magnitude of the magnetic lines of force, the magnitude of the magnetic resistance, the magnitude of the coil resistance, etc., these will cause a large deviation between the final resistance and the required data.

In order to improve such deviations, one of the effective methods is to change the above process into a “closed loop system” with a feedback device, and this feedback is magnitude of the magnetic force, which should be relatively effective. This closed-loop system can feedback the measured magnetic force to the control system at any time and compare it with the set magnetic force. If there is a deviation, the supplied current can be adjusted at any time to meet the set requirements.

### SUMMARY OF THE INVENTION

It is a primary objective of the present invention to provide a torque sensor for resistance system, which has the effect of improving the accuracy of resistance control in the resistance system, making the resistance control more precise, and meeting the needs of advanced equipment.

Another primary objective of the present invention is to provide a torque sensor for resistance system, which has a precise resistance (tension) control method, and configures the torque sensor and resistance (tension) generator in the same mechanism, making the overall structure simpler.

In order to achieve the above objectives, the present invention provides a torque sensor for resistance system, comprising a bracket, having a left board body and a right board body, then a plurality of positioning rods are used to combine them into one body, and an axis hole is provided at the relative position on the left board body and the right board body; a flywheel having an axis center, which is pivoted on the axis hole through two left and right bearings and two bearing seats, so that the flywheel can rotate on the bracket; a coil reluctance mechanism provided on a side of the outer periphery of the flywheel to provide a magnetic force to the flywheel, and the magnetic force is proportional to the applied current.

Wherein: the bearing seat has a first ring body, a positioning ring groove is provided on the outer periphery of the first ring body, and a second ring body with a larger outer diameter is provided on the inner side of the first ring body; the axis hole of the left board body and the right board body is designed as non-perfect circular elliptical hole with a groove, for the first ring body of the bearing seat to be arranged on the axis hole from the inside to the outside, the second ring body is used as the positioning surface of the inner side, and the outer side is sleeved on the positioning ring groove through a positioning unit, so that the bearing seat is not rigidly connected to the axis hole, but the bearing seat is arranged on the axis hole in a floating state; a torque sensor, including a strain block, arranged in the groove of the lateral side of the axis hole, and be arranged on the same straight line as the axis center of the flywheel and the center of the coil reluctance mechanism, and the top of the strain block extends inward to form a transverse protruding plate, the top surface of the protruding plate is configured to contact the second ring body of the bearing seat, then the bottom edge surface on the opposite side of the protruding plate is provided with a strain gauge and its connecting wire, the strain gauge will produce different resistance value changes according to the deformation amount of the strain block; and a control circuit received the change in the resistance value of the torque sensor, then calculates the change in resistance, and compares the difference between the required resistance and the actual resistance to adjust the amount of force to make the required resistance consistent with the actual resistance.

Also, a gap is provided between the axis hole and the groove for the bearing seat to be displaced in the direction of the strain block, when the first ring body of the bearing seat is placed in the axis hole.

Also, the extended side of the protruding plate at the top of the strain block is the free end and has no fixture, making it elastic for deformation.

Also, the positioning unit includes a circlip or a positioning ring to sleeve on the positioning ring groove to position the bearing seat on the axis hole.

Also, one side end of the axis center of the flywheel is locked with a first nut and a first screw, the other end is sleeved with a belt pulley, and is locked with a second nut and a second screw.

Also, the torque sensor is locked on the left board body and the right board body through a third screw.

With the above mentioned features, the present invention has below effects:
1. The torque sensor which arranged on the same straight line as the axis center of the flywheel and the center of the coil reluctance mechanism of the present invention uses the change in its resistance value as a magnetic detection device, and uses the obtained magnetic data for correcting the output current, so as to have the effect of improving the accuracy of resistance control of the resistance system, making the resistance control more precise, and meeting the requirement of the advanced device.
2. The present invention configures the torque sensor and resistance (tension) generator in the same mechanism, making the overall structure simpler.

### BRIEF DESCRIPTION OF THE DRAWINGS

FIG. 1A is a schematic diagram illustrating the electromagnetic resistance system of the prior art;

FIG. 1B is another schematic diagram illustrating the self energy generating resistance system of the prior art;

FIG. 1C is a schematic diagram illustrating the open loop system of the prior art;

FIG. 2 is an exploded perspective view of the preferred embodiment of the present invention;

FIG. 3 is a zoom-in view of the right board body of the bracket of the preferred embodiment of the present invention;

FIG. 4A is a perspective view of the torque sensor of the preferred embodiment of the present invention;

FIG. 4B is a perspective view in another angle of the torque sensor of the preferred embodiment of the present invention;

FIG. 5A is an assembled perspective view of the right side of the preferred embodiment of the present invention;

FIG. 5B is an assembled perspective view of the left side of the preferred embodiment of the present invention;

FIG. 6A is an exploded perspective view of the torque sensor and the bearing seat of the preferred embodiment of the present invention;

FIG. 6B is an assembled perspective view of the torque sensor and the bearing seat of the preferred embodiment of the present invention;

FIG. 7A is a side view of the preferred embodiment of the present invention;

FIG. 7B is a zoom-in sectional view of the 7A in FIG. 7A;

FIG. 8 is a block diagram showing the resistance control procedure of closed loop system of the present invention;

FIG. 9 is a schematic diagram showing an application of the present invention.

FIG. 10 is a schematic diagram showing another application of the present invention.

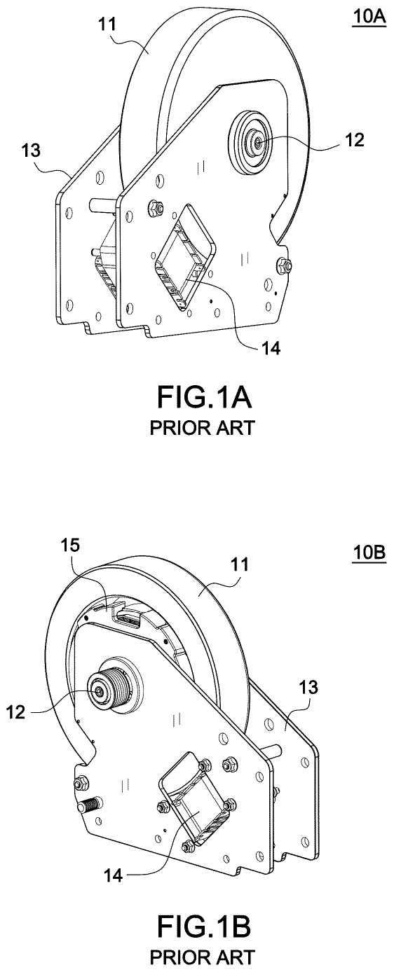

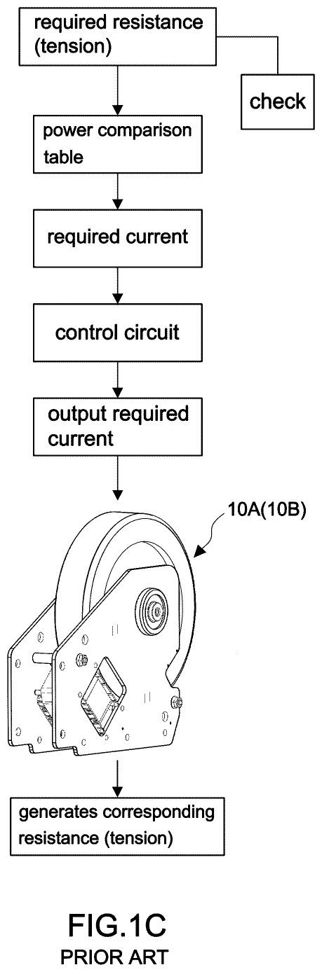

### DETAILED DESCRIPTION OF THE PREFERRED EMBODIMENT

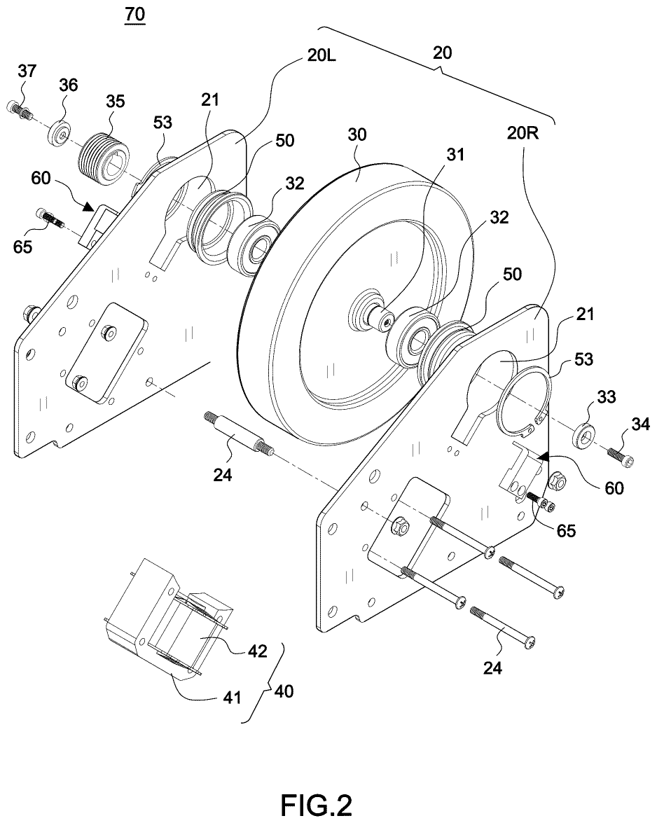

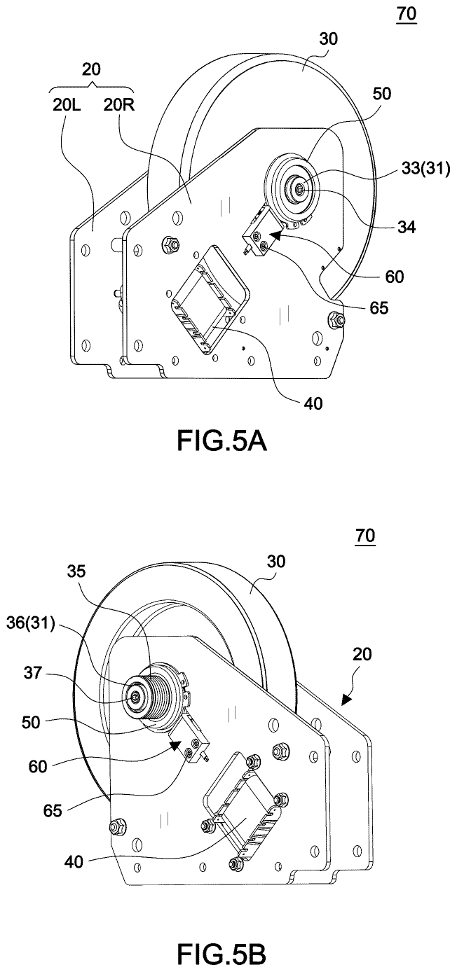

Referring to FIG. 2-8, which showing a preferred embodiment of a torque sensor for resistance system of the present invention, basically, the resistance system mentioned by the present invention, whether it is an “electromagnetic resistance system” or a “self energy generating system”, even though these two resistance systems obtain current in different ways (one is an external power supply, the other uses self generating energy), but the structural part for implementing the strain gauge feedback is basically the same, so the following embodiments only focus on the structure of the electromagnetic resistance system for description.

A resistance system 70 of the present invention includes: a bracket 20, having a left board body 20L and a right board body 20R, then a plurality of positioning rods 24 are used to combine them into one body, and an axis hole 21 is provided at the relative position on the left board body 20L and the right board body 20R; a flywheel 30 having an axis center 31, which is pivoted on the axis hole 21 through two left and right bearings 32 and two bearing seats 50, so that the flywheel 30 can rotate on the bracket 20; in this embodiment, one side end of the axis center 31 of the flywheel 30 is locked with a first nut 33 and a first screw 34, the other end is sleeved with a belt pulley 35, and is locked with a second nut 36 and a second screw 37. A coil reluctance mechanism 40 provided on a side of the outer periphery of the flywheel 30 to provide a magnetic force to the flywheel 30, and the magnetic force is proportional to the applied current; in this embodiment, the coil reluctance mechanism 40 includes an iron core 41, and formed by a coil 42 winding on the iron core 41. However, above mentioned techniques have disclosed in prior art, is not the goal of present invention, so will not be mentioned in detail.

The main features of the present invention are: the bearing seat 50 has a first ring body 51, a positioning ring groove 511 is provided on the outer periphery of the first ring body 51, and a second ring body 52 with a larger outer diameter is provided on the inner side of the first ring body 51; in this embodiment, the outer diameter of the second ring body 52 has to larger than the axis hole 21.

The axis hole 21 of the left board body 20L and the right board body 20R is designed as non-perfect circular elliptical hole with a groove 23, for the first ring body 51 of the bearing seat 50 to be arranged on the axis hole 21 from the inside to the outside, the second ring body 52 is used as the positioning surface of the inner side, and the outer side is sleeved on the positioning ring groove 511 through a positioning unit 53, so that the bearing seat 50 is not rigidly connected to the axis hole 21, but the bearing seat 51 is arranged on the axis hole 21 in a floating state; in this embodiment, the positioning unit 53 includes a circlip or a positioning ring to sleeve on the positioning ring groove 511 to position the bearing seat 50 on the axis hole 21.

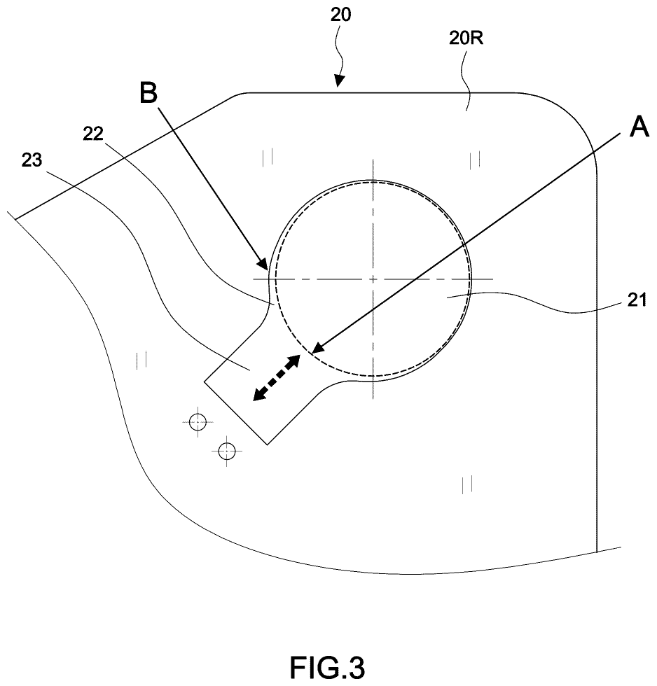

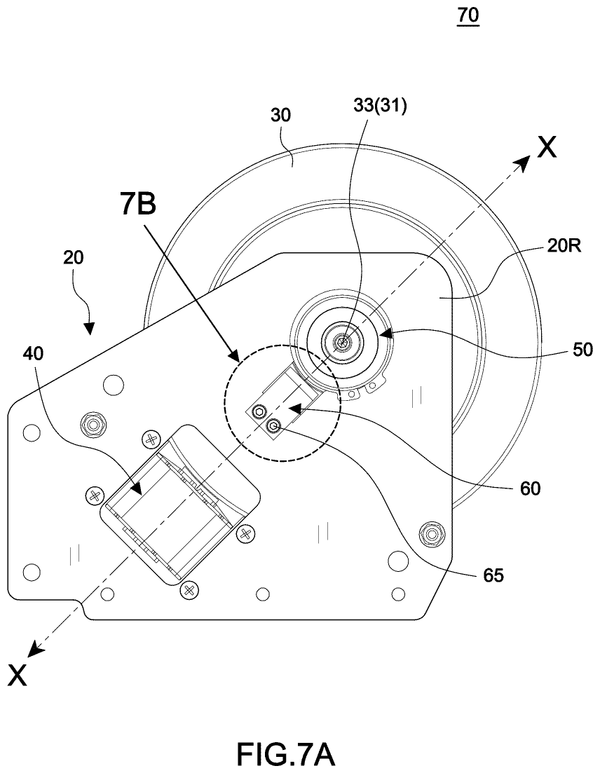

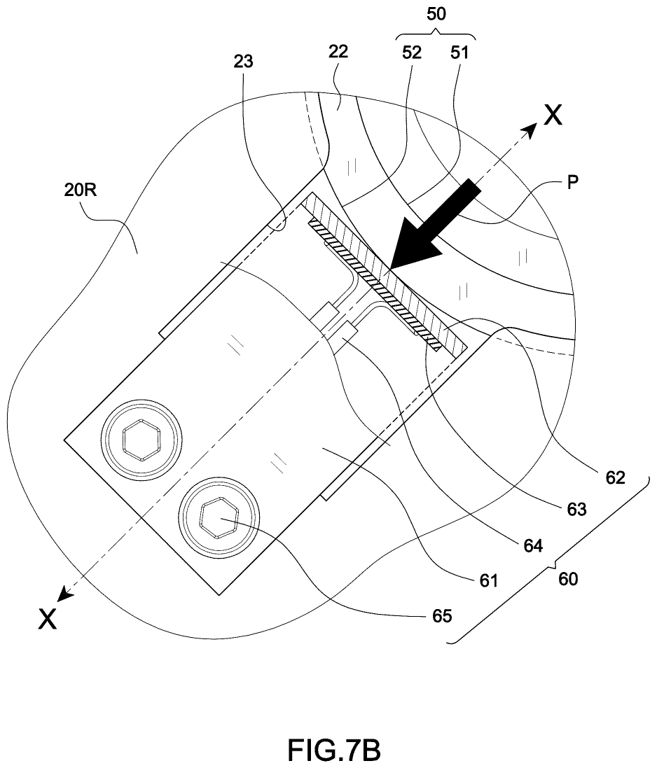

Referring to FIG. 3, which is a zoom-in view of the right board body 20R of the bracket 21, in this preferred embodiment of the present invention, a gap 22 is provided between the axis hole 21 and the groove 23 for the bearing seat 50 to be displaced in the direction of the strain block 61, when the first ring body 51 of the bearing seat 50 is placed in the axis hole 21. The dotted line A points out a perfect circle, which is the position of the first ring body 51. However, the axis hole 21 of the present invention is not a perfect circle, but has a shape pointed at position B, leaving a free gap 22 for the bearing seat 50 to move when the applied pressure (P) changes, as FIG. 7A and FIG. 7B showing.

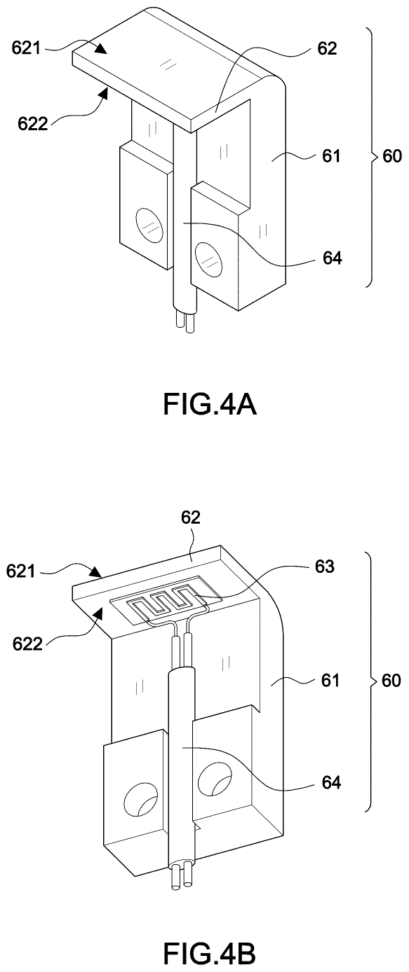

A torque sensor 60, as FIG. 4A and FIG. 4B showing, including a strain block 61, arranged in the groove 23 of the lateral side of the axis hole 21, as FIG. 7A and FIG. 7B showing, and be arranged on the same straight line (X-X) as the axis center 31 of the flywheel 30 and the center of the coil reluctance mechanism 40, and the top of the strain block 61 extends inward to form a transverse protruding plate 62, the top surface of the protruding plate 62 is configured to contact the second ring body 52 of the bearing seat 50, then the bottom edge surface 622 on the opposite side of the protruding plate 62 is provided with a strain gauge 63 and its connecting wire 64, the strain gauge 63 will produce different resistance value changes according to the deformation amount of the strain block 61.

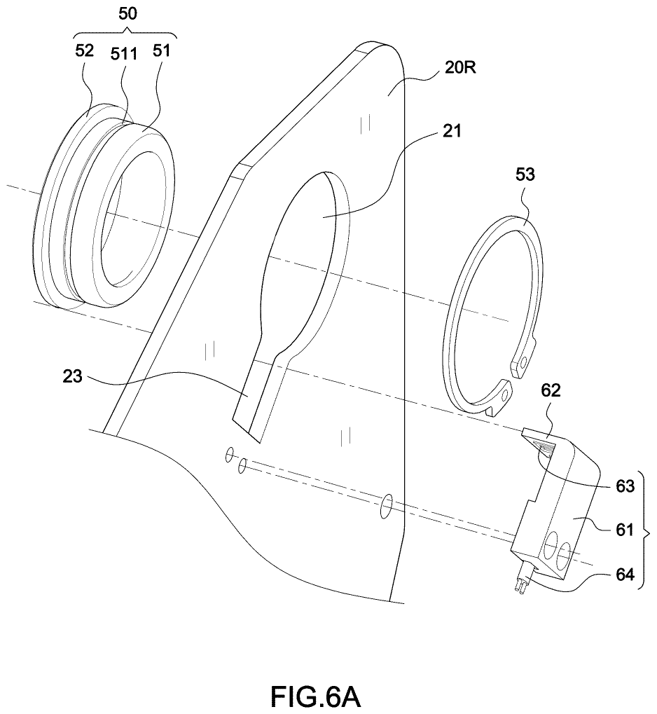

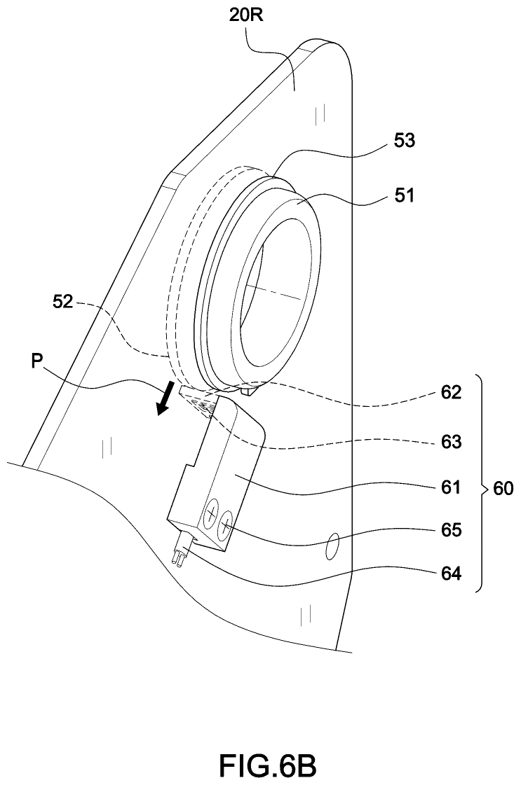

In this embodiment, the torque sensor 60 is locked on the left board body 20L and the right board body 20R through a third screw 63. As FIG. 6A and FIG. 6B showing, the extended side of the protruding plate 62 at the top of the strain block 61 is the free end and has no fixture, making it elastic for deformation. And the protruding plate 62 contacts the outer peripheral edge of the second ring body 52 in a floating state, and bears its acting pressure (P).

In this embodiment, the larger the current of the coil reluctance mechanism 40 is, the stronger the magnetic force is, and the smaller the current is, the weaker the magnetic force is. The magnetic force generated by the coil reluctance mechanism 40 will form a magnetic circuit with the flywheel 30 with magnetic conductive material, thereby attracting the flywheel 30. When the flywheel 30 is acted upon by magnetic force, since the flywheel 30 is floatingly fixed on the bracket 20, it will lean towards the coil reluctance mechanism 40, causing the strain block 61 to bear pressure and deform, thereby causing the strain gauge 63 produces a change in resistance. The greater the magnetic force applied on the flywheel 30 is, the greater the deformation of the strain block 61 will be. On the contrary, the smaller the magnetic force applied on the flywheel 30 is, the smaller the pressure on the strain block 61 will be and the smaller the deformation will be.

A control circuit 80 received the change in the resistance value of the torque sensor 60, then calculates the change in resistance, and compares the difference between the required resistance and the actual resistance to adjust the amount of force to make the required resistance consistent with the actual resistance.

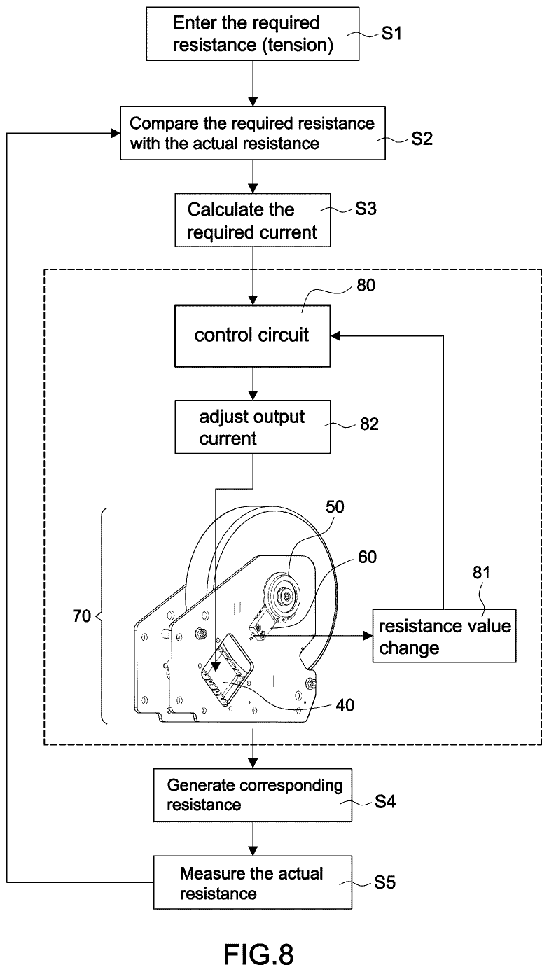

Referring to FIG. 8, which discloses the steps of the resistance control of the “closed loop system”:
S1: Enter the required resistance (tension);
S2: Compare the required resistance with the actual resistance;
S3: Calculate the required current, make the control circuit 80 adjust the output current 82 according to the resistance value change 81, and make the coil reluctance mechanism 40 change the magnetic force;
S4: Generate corresponding resistance;
S5: Measure the actual resistance, and then return to S2: compare the required resistance with the actual resistance;

According to the above-mentioned “closed-loop system”, feedback is used for the correction of the results. To form such a closed-loop system, the technical means of the present invention is to use the torque sensor 60 to use the change in resistance value as a magnetic detection device, and uses obtained magnetic data to correct the output current. In this way, many of the above-mentioned factors which affect the resistance (tension) can be reduced to minimum.

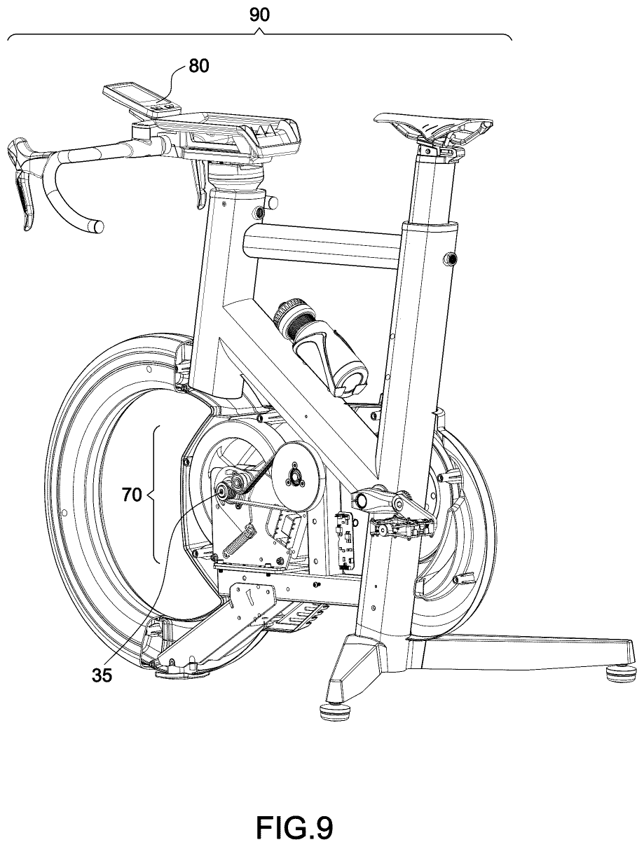

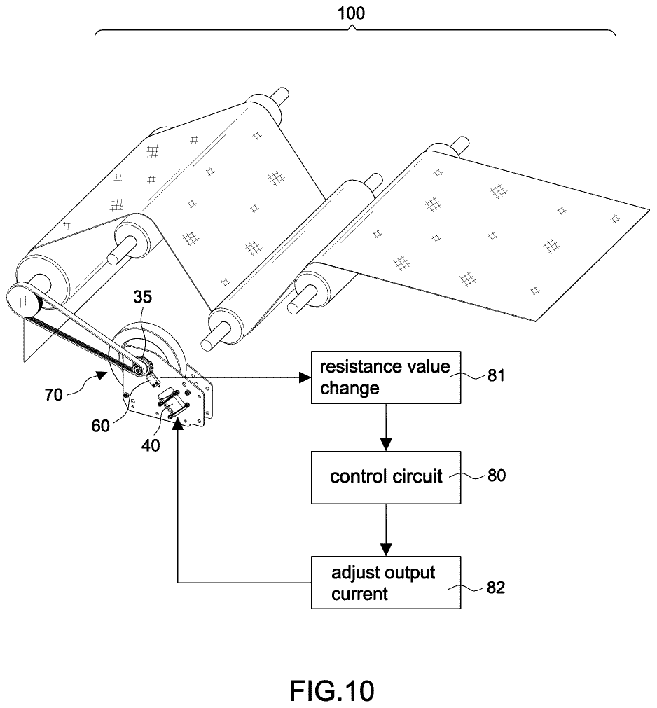

FIG. 9 is a schematic diagram showing an application of the present invention, which shows the application of the resistance system 70 on fitness and rehabilitation equipment 90; The belt pulley 35 can be used to connect the tensioning device 100, and the control circuit 80 can be arranged around the tensioning device 100. For equipment that requires strict tension control, the resistance system 70 of the “closed-loop system” of the present invention is combined with the control circuit 80, has a resistance value change 81 feedback device, and can adjust the output current 82, forming a closed-loop controlled braking system, which can achieve better control requirements, and this embodiment can well achieve the required functional characteristics in such requirements.

With the above mentioned features, the present invention has below benefits:
1. The torque sensor 60 which arranged on the same straight line as the axis center 31 of the flywheel and the center of the coil reluctance mechanism 40 of the present invention uses the change in its resistance value as a magnetic detection device, and uses the obtained magnetic data for correcting the output current, so as to have the effect of improving the accuracy of resistance control of the resistance system 70, making the resistance control more precise, and meeting the requirement of the advanced device.
2. The present invention configures the torque sensor 60 and the coil reluctance mechanism 40 in the same mechanism of the resistance system 70, making the overall structure simpler.

Although particular embodiments of the invention have been described in detail for purposes of illustration, various modifications and enhancements may be made without departing from the spirit and scope of the invention. Accordingly, the invention is not limited except as by the appended claims.

What is claimed is:

1. A torque sensor for resistance system, comprising:
a bracket 20, having a left board body 20L and a right board body 20R, then a plurality of positioning rods 24 are used to combine them into one body, and an axis hole 21 is provided at the relative position on the left board body 20L and the right board body 20R;
a flywheel 30 having an axis center 31, which is pivoted on the axis hole 21 through two left and right bearings 32 and two bearing seats 50, so that the flywheel 30 can rotate on the bracket 20;
a coil reluctance mechanism 40 provided on a side of the outer periphery of the flywheel 30 to provide a magnetic force to the flywheel 30, and the magnetic force is proportional to the applied current;
wherein:
the bearing seat 50 has a first ring body 51, a positioning ring groove 511 is provided on the outer periphery of the first ring body 51, and a second ring body 52 with a larger outer diameter is provided on the inner side of the first ring body 51;
the axis hole 21 of the left board body 20L and the right board body 20R is designed as non-perfect circular elliptical hole with a groove 23, for the first ring body 51 of the bearing seat 50 to be arranged on the axis hole 21 from the inside to the outside, the second ring body 52 is used as the positioning surface of the inner side, and the outer side is sleeved on the positioning ring groove 511 through a positioning unit 53, so that the bearing seat 50 is not rigidly connected to the axis hole 21, but the bearing seat 51 is arranged on the axis hole 21 in a floating state;
a torque sensor 60, including a strain block 61, arranged in the groove 23 of the lateral side of the axis hole 21, and be arranged on the same straight line as the axis center 31 of the flywheel 30 and the center of the coil reluctance mechanism 40, and the top of the strain block 61 extends inward to form a transverse protruding plate 62, the top surface of the protruding plate 62 is configured to contact the second ring body 52 of the bearing seat 50, then the bottom edge surface on the opposite side of the protruding plate 62 is provided with a strain gauge 63 and its connecting wire, the strain gauge will produce different resistance value changes according to the deformation amount of the strain block 61; and
a control circuit 80 received the change in the resistance value of the torque sensor 60, then calculates the change in resistance, and compares the difference between the required resistance and the actual resistance to adjust the amount of force to make the required resistance consistent with the actual resistance.

2. The torque sensor for resistance system as claimed in claim 1, wherein a gap 22 is provided between the axis hole 21 and the groove 23 for the bearing seat 50 to be displaced in the direction of the strain block 61, when the first ring body 51 of the bearing seat 50 is placed in the axis hole 21.

3. The torque sensor for resistance system as claimed in claim 2, wherein the extended side of the protruding plate 62 at the top of the strain block 61 is the free end and has no fixture, making it elastic for deformation.

4. The torque sensor for resistance system as claimed in claim 1, wherein the positioning unit 53 includes a circlip or a positioning ring to sleeve on the positioning ring groove 511 to position the bearing seat 50 on the axis hole 21.

5. The torque sensor for resistance system as claimed in claim 1, wherein one side end of the axis center 31 of the flywheel 30 is locked with a first nut 33 and a first screw 34, the other end is sleeved with a belt pulley 35, and is locked with a second nut 36 and a second screw 37.

6. The torque sensor for resistance system as claimed in claim 1, wherein the torque sensor 60 is locked on the left board body 20L and the right board body 20R through a third screw 63.
